(19) United States
(12) Patent Application Publication
(10) Pub. No.: US 2010/0084873 A1
(43) Pub. Date: Apr. 8, 2010

(54) SYSTEM FOR PRODUCING ENERGY THROUGH THE ACTION OF WIND

(76) Inventor: Glenn L. Beane, Hanover, NH (US)

Correspondence Address: DEVINE, MILLIMET & BRANCH, P.A., 111 AMHERST STREET, BOX 719, MANCHESTER, NH, 03105, US

(21) Appl. No.: 12/575,195

(22) Filed: Oct. 7, 2009

Related U.S. Application Data
(60) Provisional application No. 61/195,513, filed on Oct. 8, 2008.

(51) Int. Cl. F03D 9/00

(52) U.S. Cl. 290/55

(57) ABSTRACT

A system and method of generating energy by transforming energy from a low-density substance, such as air flow or wind, into kinetic energy by directing the flow through a wind guide system towards panels that rotate in generally the same direction as the air flow. Furthermore, the system uses the ground and/or water as a surface for guiding the air flow towards the windmill devices. The wind guide system also limits air flow from engaging all the panels at the same.

### CROSS-REFERENCE TO RELATED APPLICATIONS

The present application claims the benefit of Provisional Patent Application No. 61/195,513 filed Oct. 8, 2008, which is incorporated herein by reference.

### FIELD OF THE INVENTION

The present invention is a system and method for producing energy from the action of wind. More particularly, it is a system and method for producing electricity through the action of wind on a wind wheel.

### BACKGROUND OF THE INVENTION

There are numerous approaches to producing electricity from the movement of air or wind. Conventional systems place a series of large blades, blades generally over 30 feet, that rotate about a hub. The hub is positioned on the pole or tower and is located generally at least 80 feet above the ground or water. The blades generally rotate in a direction that is perpendicular to the flow of the air, i.e. wind. The system requires anchoring systems to secure the pole. In addition, it is generally desirous to have the blades even further from the ground to minimize ground effects.

Unfortunately, prior attempts to produce electrical power from wind have failed to appreciate the benefits of ground effect. Furthermore, some systems have complicated the structures by requiring massive support structures and complicated gearing.

### SUMMARY OF THE INVENTION

The present invention is a system and method for producing electricity through the movement of air, also referred to as wind. The system comprises a wind device, a wind guide system, and a mechanism to convert the rotational energy of the shaft into another form of energy.

The wind device includes a mounting structure for securing to the ground; a horizontal rotatable shaft, rotatably carried by the mounting structure; at least three wind engaging panels; and at least three panel mounting structures projecting from the horizontal rotatable shaft. The panel mounting structure is rotatable with the horizontal rotatable shaft. Each panel mounting structure carries one of the wind engaging panels.

The wind guide system assists in directing the air flow towards the wind engaging panels while limiting air flow from engaging all the panels at the same time.

In contrast to conventional methods, the system 1) uses the ground structure such as the ground or bodies of water to assist in directing the air flow, and 2) limits air flow from engaging all panels at the same time.

In an embodiment, the mechanism to convert the rotational energy of the shaft is an electrical generator and the other form of energy is electrical energy. The electrical generator is a fly wheel.

In an embodiment, the panels and/or windscreen are covered with artwork. The wind guide system is a man-made physical structure. The man-made physical structure is a panel. The man-made physical structure is formed of the same material as the wind engaging panels.

In an embodiment, the wind guide system is an earthen form. In one embodiment, the earthen form is a berm. In one embodiment, the earthen form is a sand dune.

In an embodiment, the wind guide system is a series of plants.

In an embodiment, the system has four wind engaging panels wherein the air flow engages the panels generally perpendicular to the plane of the panel and in the direction of rotation of the panel.

In an embodiment, the wind engaging panels extend to a point near the horizontal shaft defining a gap between the panel and the shaft to allow air flow on all sides of the panel therein creating a low pressure area behind the panel to assist in the movement of the panel.

A system for generating energy from the movement of air includes a plurality of wind devices, a wind guide system, and a mechanism to convert the rotational energy of the shaft into another form of energy. Each of the wind devices includes a mounting structure for securing to the ground; a horizontal rotatable shaft, rotatably carried by the mounting structure; at least three wind engaging panels; and at least three panel mounting structures projecting from the horizontal rotatable shaft. The panel mounting structure is rotatable with the horizontal rotatable shaft. Each panel mounting structure carries one of the wind engaging panels.

The wind guide system assists in directing the air flow towards the wind engaging panels while limiting air flow from engaging all the panels at the same time.

### BRIEF DESCRIPTION OF THE DRAWINGS

These and other features and advantages of the present invention will be better understood by reading the following detailed description of embodiments, taken together with the drawings wherein:

FIG. 1 is a perspective view of a system for generating energy from the movement of air;

FIG. 2 is a front view of the system for generating energy from the movement of air;

FIG. 3 is a rear view of the system for generating energy from the movement of air;

FIG. 4 is a schematic top view of the system for generating energy from the movement of air;

FIG. 5A is a schematic side view of the system for generating energy from the movement of air;

FIG. 5B is an enlarged portion of the schematic side view of FIG. 5A showing a portion of the system;

FIG. 6 is a schematic top view of the system for generating energy from the movement of air showing a plurality of windmill devices;

FIG. 7 is a schematic top view of an alternative system with another arrangement of a plurality of windmill devices;

FIG. 8 is a schematic top view of an alternative system with a windmill device near the ocean;

FIG. 9 is a schematic top view of an alternative system for generating energy from the movement of air;

FIG. 10 is a schematic side view of an alternative system for generating energy from the movement of air;

FIG. 11 is a perspective view of another alternative system for generating energy from the movement of air;

FIG. 12 is a side view of the alternative system of FIG. 11;

FIG. 13 is a front view of the alternative system of FIG. 11; and

FIG. 14 is a top schematic view of the alternative system of FIG. 11.

### DETAILED DESCRIPTION OF EMBODIMENTS

There are numerous factors that cause the movement of air or wind. These factors include differential heating between the equator and the poles and the rotation of the planet.

A system and method of generating energy by transforming energy from a low-density substance, such as air flow or wind, into kinetic energy by directing the flow through a wind guide system towards panels that rotate in generally the same directions as the air flow. Furthermore, the system uses the ground and/or water as a surface for guiding the air flow towards the windmill devices. The wind guide system also limits air flow from engaging all the panels at the same.

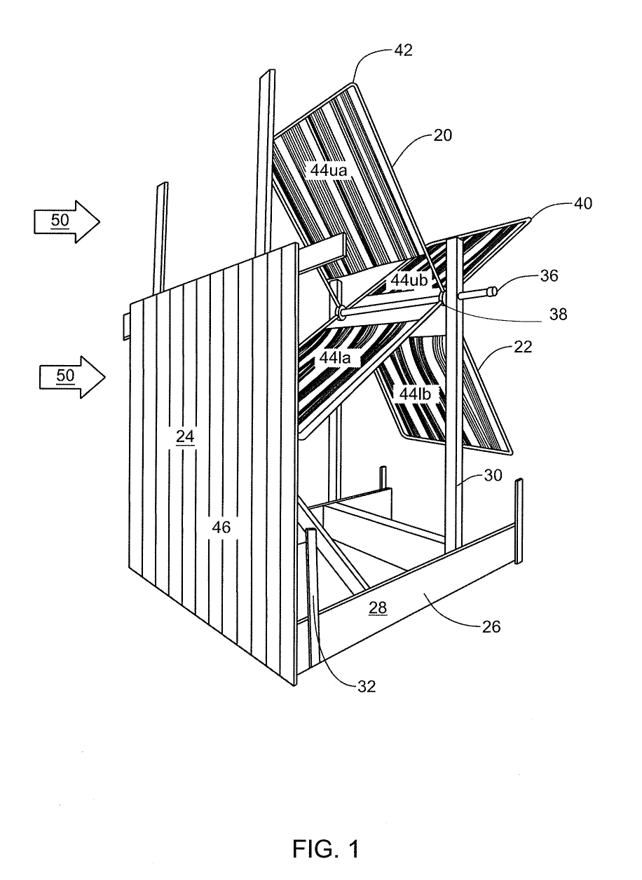

Referring to FIG. 1, a system 20 having a windmill device 22 and a wind guide system 24 is shown. The windmill device 22 has a mounting structure 26. In the embodiment shown, the mounting structure 26 is a ground structure 28 having an “H” shaped structure and a pair of vertical mounting poles 30. In addition, the mounting structure 26 has four leveling poles 32, only three seen in the FIG.

The windmill device 22 has a horizontal rotatable shaft 36. The rotatable shaft 36 is carried by the pair of vertical mounting poles 30 of the mounting structure 26.

The windmill device 22 has a plurality of wind engaging structures 40. In the embodiment shown, there are four wind engaging structures 40 secured to the horizontal rotatable shaft 36. Each of the wind engaging structures 40 has a frame 42, which in the embodiment shown is “U” shaped. The frame 42 is secured to the rotatable shaft 36 by a pair of hubs 38. The frame 42 carries a wind engaging panel 44.

Still referring to FIG. 1, the wind guide system 24 includes a wind block 46 that limits air flow towards the lower wind engaging panels 441a and 441b. The air flow 50 hits the wind engaging panel 44ua and pushes the panel therein rotating the shaft 36.

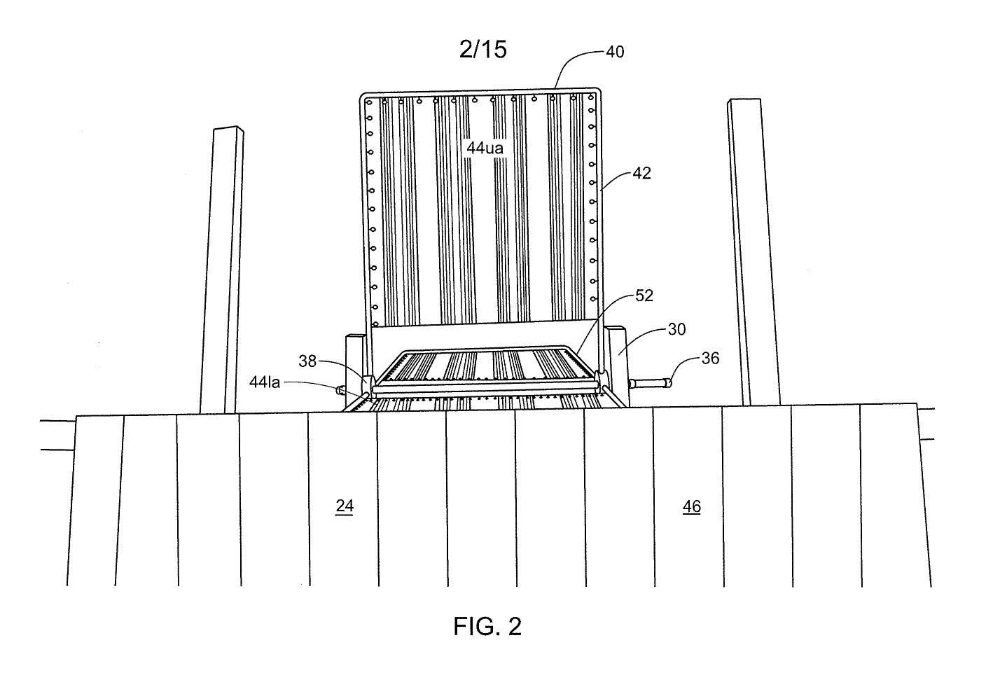

Referring to FIG. 2, a front view of the system 20 with the wind block 46 diverting air flow from the lower wind engaging panel 441a. As the air flow rotates the wind engaging structures 40 about the horizontal rotatable shaft 36 of the windmill device 22, the panel 44 that is engaged by the air flow changes. While the panels 44 are labeled dependent on their position in a particular figure, as the wind engaging structures 40 rotate on the windmill device 22, each panel 44 will be in all positions.

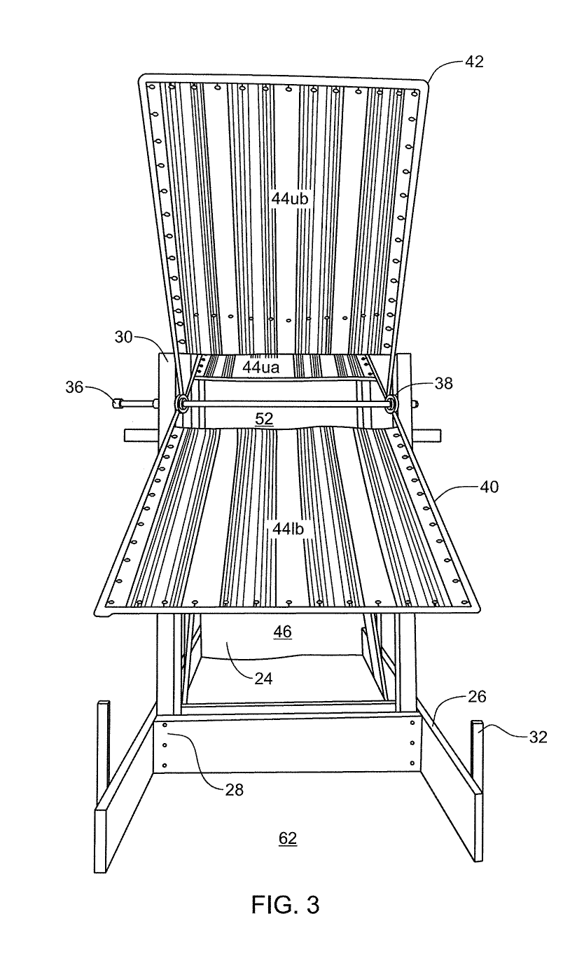

Referring to FIG. 3, a rear view of the system 20 for generating energy from the movement of air is shown. A pair of the leveling poles 32 are shown raising a portion of the ground structure 28 above the earth or ground. The lower wind engaging panel 441b shown is generally not affected by wind flow in its current position since the wind block 46, a portion shown at the rear of the FIG, blocks the air flow, wind, from engaging the lower wind engaging panels. The upper wind engaging panel 44ub, shown in forward of the figure, is being forced downward by the air flow. The upper wind engaging panel 44ua, shown in the rear of the figure, is engaged with the majority of the air flow directed by the wind guide system 24 including the wind block 46.

Still referring to FIG. 3, the wind engaging structure 40 has a gap 52 between each of the wind engaging panels 44 and the horizontal rotatable shaft 36. The gap 52 in combination with the wind engaging panel 44 creates a venture effect and lower pressure behind the wind engaging panel 44. The lower pressure assists in the rotation of the windmill device 22 by drawing the wind engaging structure 40 in the same direction as the air flow forces the panels 44.

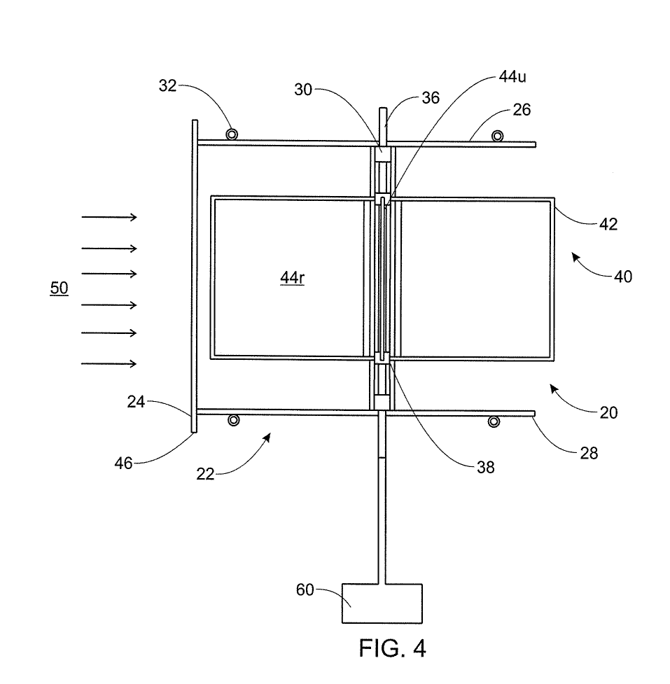

Referring to FIG. 4, a schematic top view of the system 20 for generating energy from the movement of air is shown. The wind guide system 24 includes the wind block 46. The windmill device 22 of the system 20 includes the mounting structure 26. The mounting structure 26 has the ground structure 28 and the leveling poles 32. The horizontal rotatable shaft 36 extends between the pair of mounting poles 30.

The wind engaging panel 44u, which is projecting vertically out of the page, is hit by the air flow 50 which because of the orientation of the system 20 moves the wind engaging panel 44u to the right in the FIG. The wind engaging panel 44r, the panel 44 near the wind block 46, is rotated upward by the rotation of the rotatable shaft 36, which is being rotated by the force of the air flow on the wind engaging panel 44u. As the wind engaging panel 44r rotates upward, the air flow will engage the panel 44 and assist in the rotation of the rotatable shaft 36.

Still referring to FIG. 4, the horizontal rotatable shaft 36 is attached to a generator 60 that converts the rotational energy of the shaft 36 into electrical power. In one embodiment, the generator 60 is a flywheel generator. The flywheel generator 60 is a three-phase 12-pole brushless permanent magnet generator. The stator has three-phase winding. The rotor has the 12 high-energy rare earth permanent magnets.

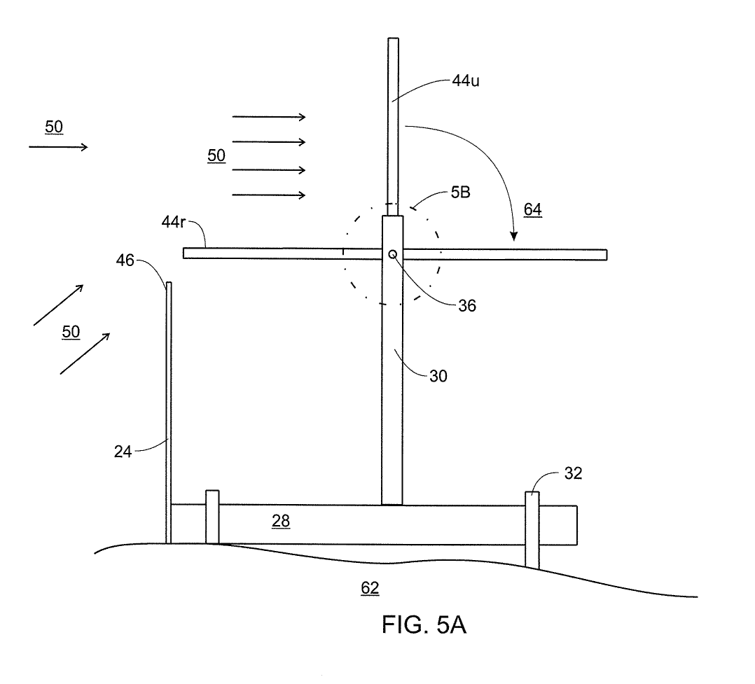

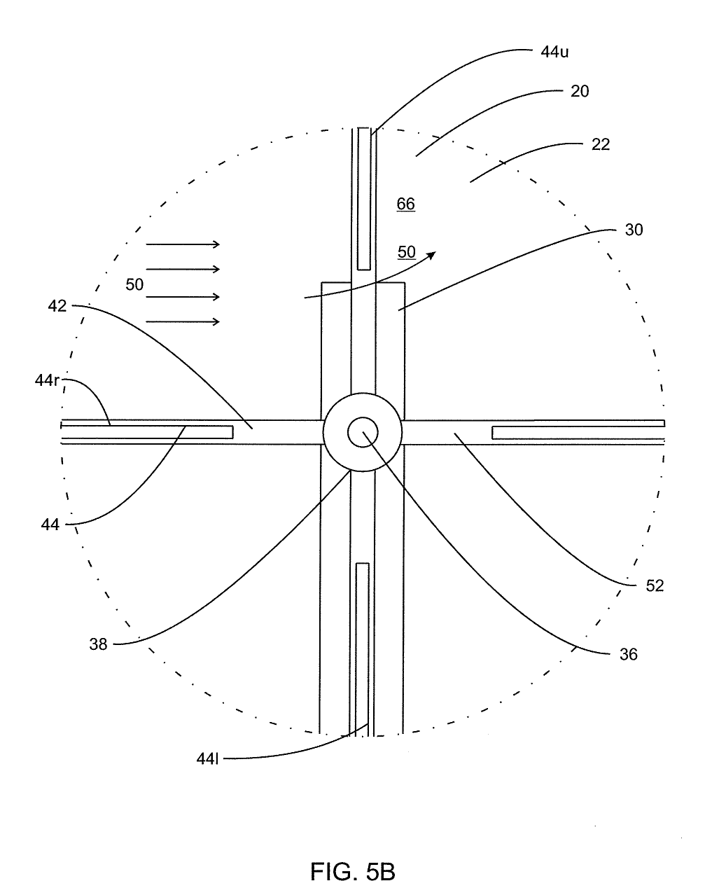

Referring to FIG. 5A, a schematic side view of the system 20 for generating energy from the movement of air is shown. The wind guide system 24 includes the wind block 46, which is shown to the left of the windmill device 22 in the FIG. The mounting structure 26 includes the ground structure 28 and the leveling poles 32. The leveling poles 32 raise the rear portion of the ground structure 28, on the right side of the FIG. 5A, above the ground surface 62.

The air flow 50 hits the wind engaging panel 44u causing the wind engaging panels 44 to rotate in a clockwise direction, as represented by arrow 64, therein rotating the horizontal rotatable shaft 36 in a clockwise direction. As indicated above with respect to FIG. 4, the wind engaging panel 44r, the panel 44 near the wind block 46 is rotated upward by the rotation of the rotatable shaft 36, which is being rotated by the force of the air flow on the wind engaging panel 44u. As the wind engaging panel 44r rotates upward, the air flow will engage the panel 44 and assist in the rotation of the rotatable shaft 36.

Referring to FIG. 5B, an enlarged portion of the schematic side view of FIG. 5A showing a portion of the windmill device 22 of the system 20 is shown. The frame 42 of the wind engaging structure 40 is connected to the hubs 38 that rotate with the horizontal rotatable shaft 36. The frame 42 retains the wind engaging panel 44 which in the embodiment shown is made of fabric such as awning canvas. The wind engaging panel 44 is spaced from the hubs 38 and the horizontal rotatable shaft 36. The gap 52 between the horizontal rotatable shaft 36 and the wind engaging panel 44 allows a portion of the air flow 50 to create a low pressure zone 66 behind the wind engaging panel 44, on the side opposite from the side engaged by the air flow. It is recognized also that the air flow 50 going around the wind block 46 creates a low pressure zone 66 behind the block 46.

In one embodiment, each of the four panels 44 is formed of awning canvas. Each panel 44 is generally 5 feet wide by 8 feet tall. The air gap 52 between the panel 44 and the rotatable shaft 33 is approximately 1 foot. The further the surface area of the panel 44 is from rotating shaft the more the torque.

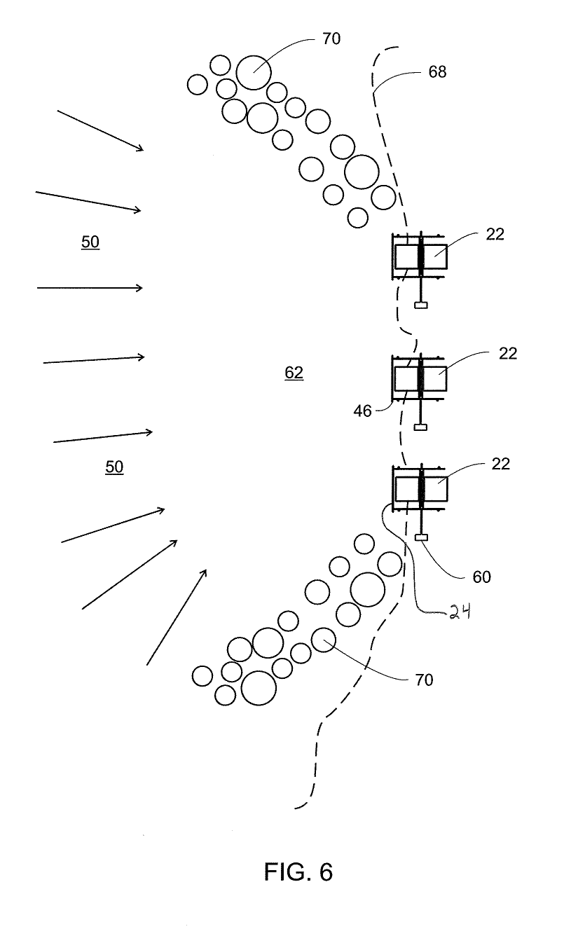

Referring to FIG. 6, a schematic top view of the system 20 showing a plurality of windmill devices 22 and a wind guide system 24 is shown. The system 20 is placed in proximity to a ridge of a mountain or hill. The ridge 68 is symbolized by the dash line 68. The wind guide system 24 of the system 20 includes a series of trees or brush 70 that block or limit the flow of air over the ridge 68 at certain locations and direct such flow towards the windmill devices 22. The system 20 shows three (3) windmill devices 22 located at the ridge. Each of the windmill devices 22 has a wind block 46 as part of the wind guide system 24 as explained above with respect to FIGS. 1-5B.

As indicated above, the system 20 uses the existing ground surface 62 to assist in guiding the air flow 50 to the windmill device 22. This is in contrast to conventional windmills that are positioned so that the blades are not in proximity to the ground. The placement of natural products such as trees or brush 70 does not detract from the view in proximity to the windmill devices 22 while guiding the air flow 50 as part of the system 20.

In some embodiments, the windmill device 22 and the wind block 46 can have artwork to complement the surroundings or to make a statement. Likewise, the wind block 46 could have bushes located in proximity to hide the wind block 46 and the panels 44 could be of a neutral color to blend with the environment.

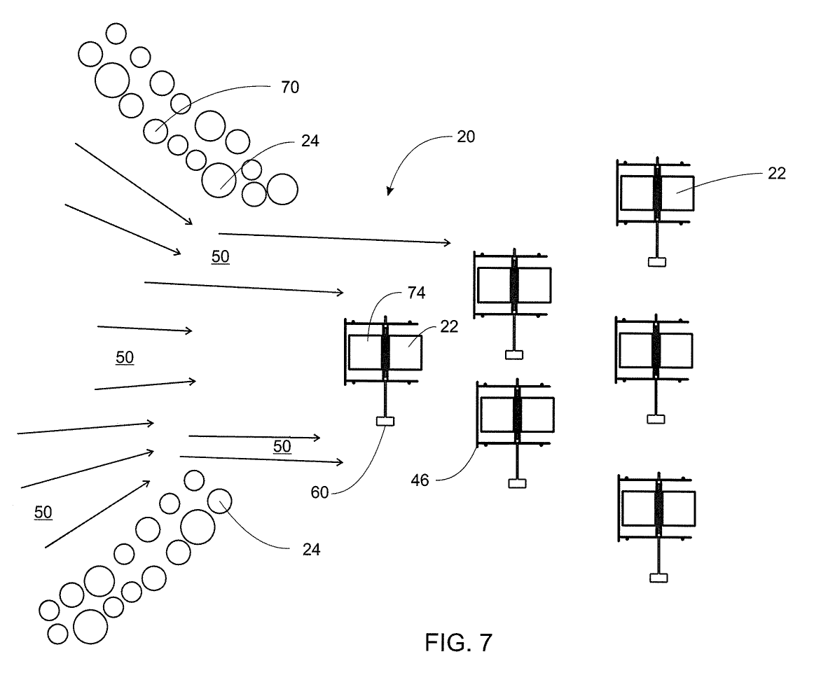

As indicated above, the windmill devices 22 are generally placed to work with the existing environments. Referring to FIG. 7, a schematic top view of an alternative system 20 with another arrangement of a plurality of windmill devices 22 is shown. The topography in this embodiment has a general open area with a prevailing wind in one direction. The system 20 includes the wind guide system 24 having a series of trees or brush 70 that block or limit the flow of air across a portion of the general open area and direct such flow towards a windmill device 22. Behind the windmill device 22 is a series of additional windmill devices 22 that are arranged in a “V” shape or triangular pattern.

The trees 70 and/or brush 70 of the wind guide system 24 guides the air flow 50 generally to the first or head pin windmill device 74. As the air flow 50 spreads out after passing through the head pin windmill device 74, the other five (5) windmill devices 22 in the embodiment shown extract more energy.

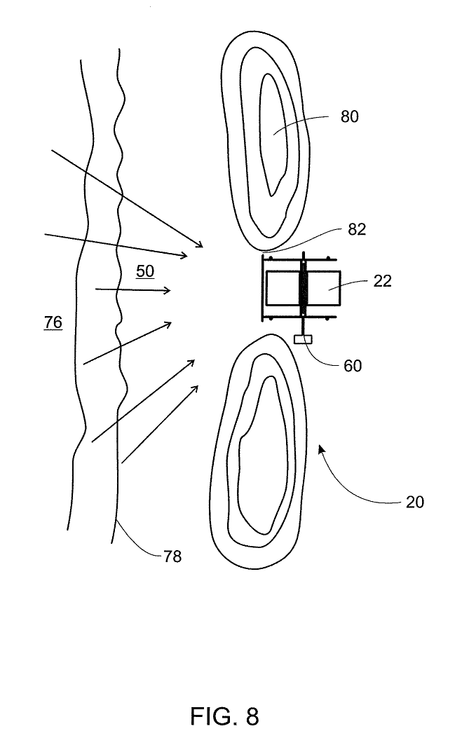

FIG. 8 is a schematic top view of an alternative system 20 with a windmill 22 device near the water. The body of water 76, such as an ocean or lake, presents an area from which wind flow can be directed to a system for generating energy from the movement of air 20. The system 20 located on the shores 78 near the body of water 76 has a pair of berms or sand dunes 80 that form a portion of the wind guide system 20. In the embodiment shown, a single windmill device 22 is positioned in a space 82 between the dunes 80. Each of the windmill devices 22 has a wind block 46 as part of the wind guide system 24 as explained above with respect to FIGS. 1-4.

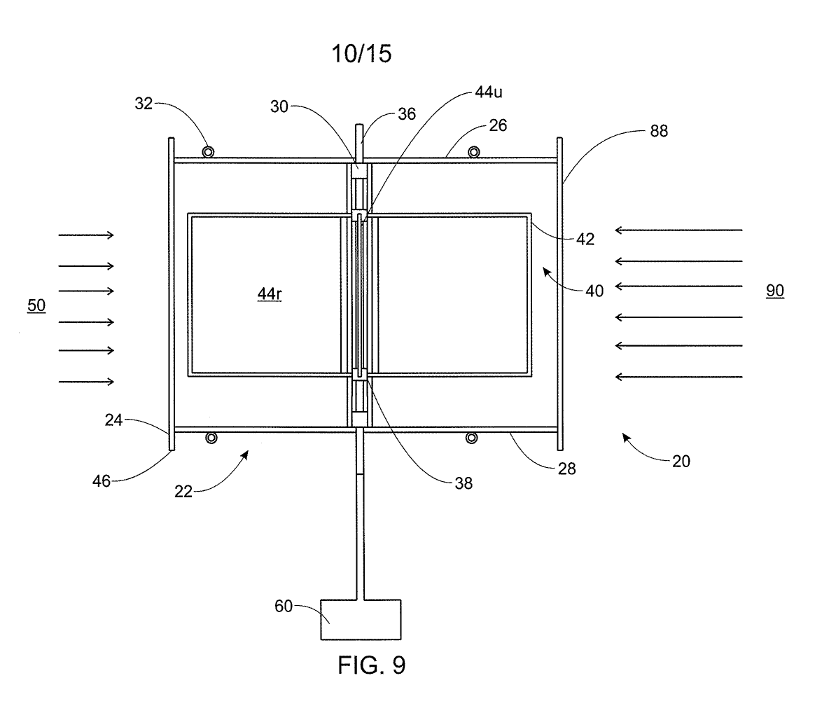

Referring to FIG. 9, a schematic top view of an alternative system for generating energy from the movement of air is shown. The wind guide system 24 includes the wind blocks 46 and 88. Similar to the previous embodiments, the windmill device 22 of the system 20 of this embodiment includes the mounting structure 26. The mounting structure 26 has the ground structure 28 and the leveling poles 32. The horizontal rotatable shaft 36 extends between the pair of mounting poles 30.

The wind engaging panel 44u, which is projecting vertically out of the page, is hit by the air flow 50 which because of the orientation of the system 20 moves the wind engaging panel 44u to the right in the FIG. The wind engaging panel 44r, the panel 44 near the wind block 46, is rotated upward by the rotation of the rotatable shaft 36, which is being rotated by the force of the air flow on the wind engaging panel 44u. As the wind engaging panel 44r rotates upward, the air flow will engage the panel 44 and assist in the rotation of the rotatable shaft 36.

In contrast to the previous embodiment, the system 20 has the additional wind block 88 of the wind guide system 24. The wind block 88 guides the air flow when the air flow is coming from the opposite direction than represented by the arrows 50. The air flow in the other direction is represented by the arrows 90. In certain locations, the air flow will generally be in one direction as represented by air flow arrows 50. However in certain situations, typically less than twenty five (25) percent of the time, the air flow will be in the opposite direction as represented by arrows 90.

Still referring to FIG. 9, the horizontal rotatable shaft 36 is attached to a generator 60 that converts the rotational energy of the shaft 36 into electrical power. The system 20 will allow power to be generated regardless if the shaft 36 is rotating clockwise as seen in FIG. 5A or in a counterclockwise direction.

In an embodiment, the generator 60 is a flywheel generator. The flywheel generator 60 is a three-phase 12-pole brushless permanent magnet generator. The stator has three-phase winding. The rotor has 12 high-energy rare earth permanent magnet.

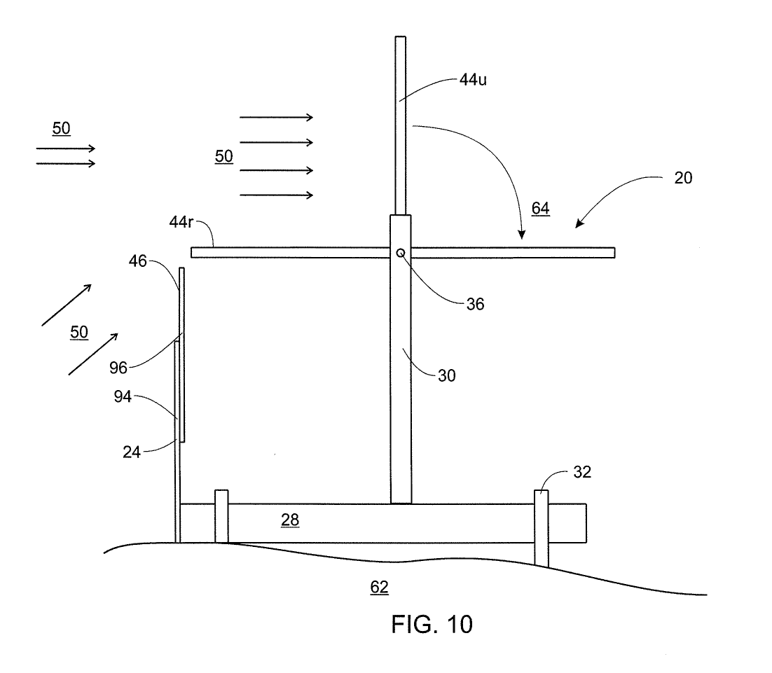

Referring to FIG. 10, a schematic side view of an alternative system for generating energy from the movement of air is shown. The wind guide system 24 includes the wind block 46, which is shown to the left of the windmill device 22 in the FIG. The wind block 46 has a pair of panels 94 and 96. The upper panel 96 is adjustable relative to the lower panel 94 and the wind mill device 22. The wind block 46 can be adjusted dependent on several factors including the direction and velocity of the air flow movement. It recognized that the embodiment shown in FIG. 9 and other embodiments can have adjustable panels 96.

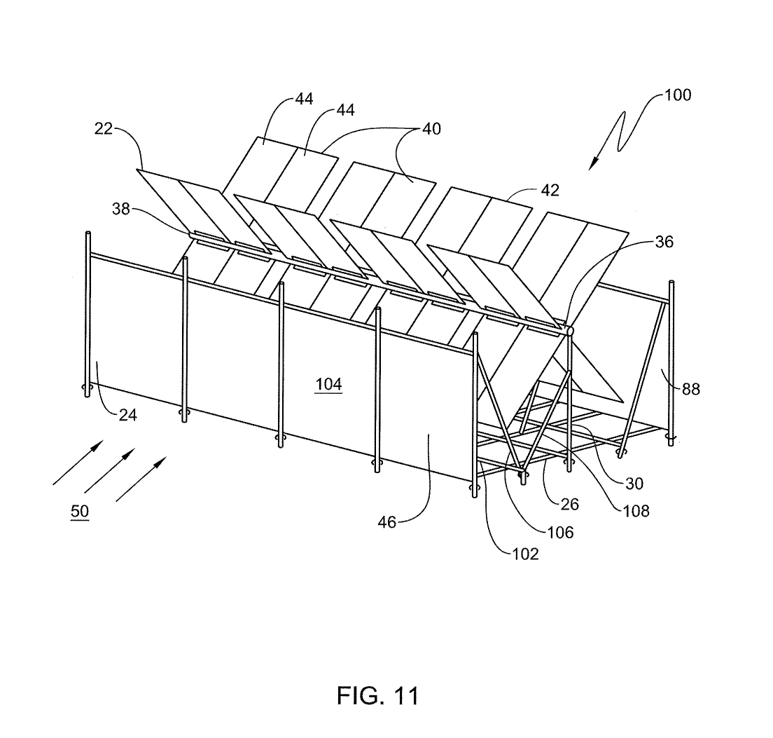

Referring to FIG. 11, a perspective view of an alternative system 100 for generating energy from the movement of air is shown. The system 100 has a windmill device 22 and a wind guide system 24. The windmill device 22 has a mounting structure 26, a plurality of vertical mounting poles 30, and a horizontal rotatable shaft 36. The windmill device 22 in addition has a plurality of wind engaging surfaces 40. In the embodiment shown, there are four (4) sets of wind engaging structures each set having four (4) wind engaging structures 40 secured to the horizontal rotatable shaft 36. Each of the wind engaging structures 40 has a frame 42, which in the embodiment shown is a pair of rectangles. The frame 42 is secured to the rotatable shaft 36 by a series of hubs 38. The frame 42 carries a pair of wind engaging panels 44.

While the four (4) sets of four (4) wind engaging structures 40 are shown aligned with each other, it is recognized that each set could be off-set. For example, it may be determined that the primary direction of the wind cannot be exactly perpendicular to the wind engaging structures 40 so therefore a slight off-set of each wind engaging structure 40 is more beneficial.

Still referring to FIG. 11, similar to FIG. 9 the system 100 has a pair of wind blocks 46 and 88 of the wind guide system 24 wherein the wind blocks 46 and 88 guide the airflow when the airflow is coming from either the primary direction or a direction 180° from the primary direction. Both the wind blocks 46 and 88 in the embodiment shown are formed similar to the wind engaging structures 40 by a frame 102 and a panel 104.

The frame 102 of the wind guide system 24 is tied to the mounting structure 26 of the windmill device 22. In the embodiment shown, a stiffening arm 106 extends from the top of the wind block 88 of the wind guide system 24 to the mounting structure 26. A similar stiffening arm 108 is located from vertical mounting poles 30 to which the rotatable shaft 36 is mounted.

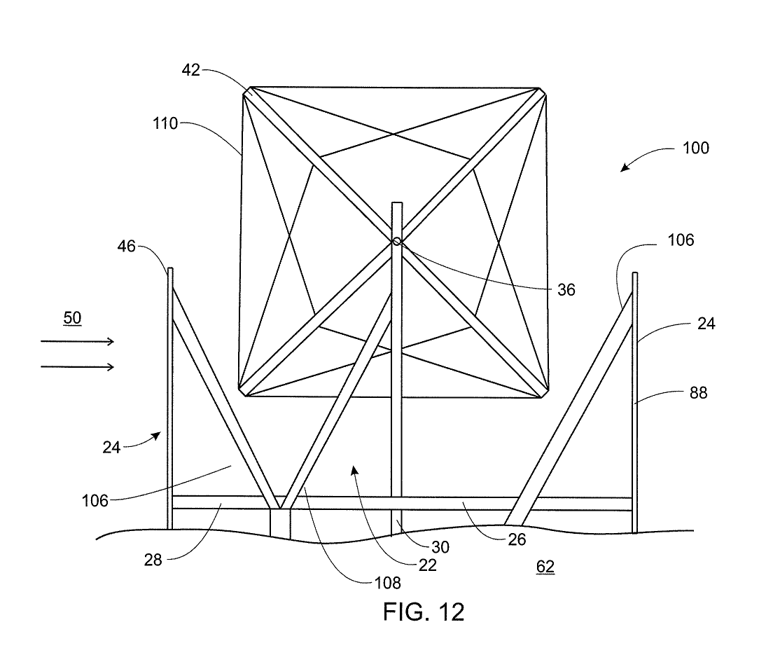

Referring to FIG. 12, a side view of the alternate structure of FIG. 11 is shown. A series of guide wires 110 extend between the frames 42 of adjacent wind engaging structures 40 to stiffen the structure and allow the system 100 to be used in various weather conditions including when the system is exposed to snow and ice. The stiffening arms 108 are shown extending from the vertical mounting poles 30 which hold the rotatable shaft 36. The stiffening arms 106 are also shown extending from the top of the wind blocks 46 and 88 to the mounting structure 26.

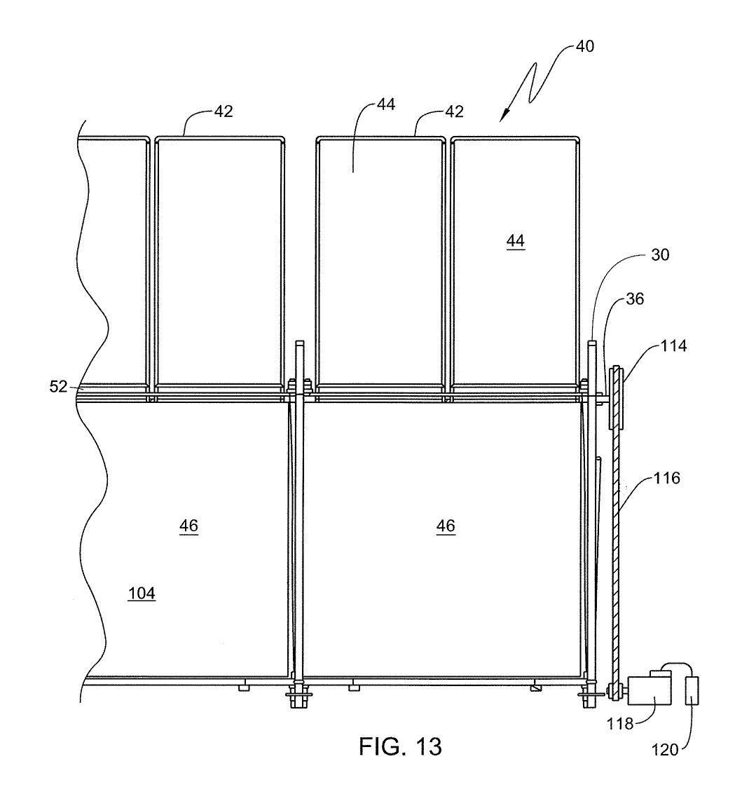

Referring to FIG. 13, a front view of the alternative structure 100 of FIG. 11 is shown. The wind block 88 is shown limiting the air flow to all but one of the wind engaging structures 40. On the right side of the FIG. a pulley 114 is connected to the rotatable shaft 36. A belt 116 extends from the pulley 114 to a generator 118 such that as the wind, the air flow 50, hits the wind engaging structure 40 the generator 118 rotates to generate electricity. The system 100 has an inverter 120 which converts the direct current (DC) power from the generator 118 to alternative current (AC) power.

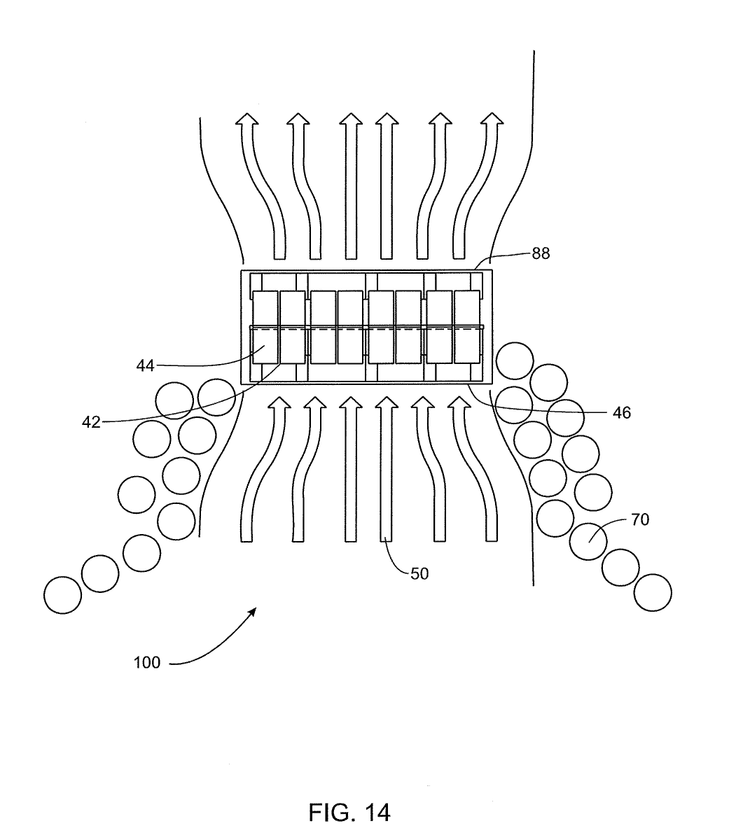

Referring to FIG. 14, a top schematic view of the system 100 of FIG. 11 is shown. The wind guide system 24 in addition to the wind blocks 46 and 88 has other structures such as series of trees or brush 70 to direct the air toward the windmill device 22. The increase in speed of the air as it approaches the windmill device 22 results in faster rotation of the rotatable shaft 36 therein generating electricity.

In one embodiment, the generator 118 can be a permanent magnetic (PM) generator such as marketed by Inergy of Plantation, Fla. The PM generator can produce power for the inverter 120 as the rotatable shaft 38 rotates both varying speed and torque. In the embodiment, the inverter 120 can be an inverter such as the PVI-6000-OUTD-US-W marketed by Power-One Inc. of Camarillo, Calif., takes the direct current (DC) power of the generator and outputs an alternating current (AC) single phase power.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

It is recognized that the wind block 46 can come in various forms. While the wind block 46 has been described above as natural structures such as trees and brush and also as man-made structures such as canvas, plywood, or art, it is recognize that the structure can take other forms including brick walls and display screens.

It is recognized that instead of converting the energy into electricity through a generator and an inverter, the kinetic energy from the rotating shaft can be used to operate a pump that pressurizes a hydraulic accumulator. In that the rotation of the shaft may not be constant, the pumping may not be constant, but the hydraulic accumulator stores the unregulated energy. The pressure from the hydraulic accumulator then regulates this energy with a valve and uses this regulated energy to operate a hydraulic motor at a fixed RPM that drives a generator to produce AC at a regulated voltage and frequency for one's house or grid tie-in. The accumulator acts both as an energy storage and regulating device. The regulating valve would shut off, turning off the generator, whenever pressure in the accumulator drops below a set-point, and the energy creating device would then recharge the accumulator.

It is recognized alternatively that an electromechanically-controlled variable displacement hydraulic pump can be used to regulate a constant flow to a generator. The frequency of the electricity generated is regulated. The voltage is increased or decreased by increasing or decreasing the pressure (pounds per square inches (PSI)) driving the generator as wind speed increases or decreases.

Furthermore, the generator can be tied into the grid, the power system. The generator is started by the grid and therefore is in synch with the grid. The wind system 20 rotating the shaft 36 engages the generator to drive the generator which is synchronized with the grid.

The invention claimed is:

1. A system for generating energy from the movement of air, also referred to as wind, the system comprising:
a wind device comprising:
a mounting structure for securing to the ground;
a horizontal rotatable shaft, rotatably carried by the mounting structure;
at least three wind engaging panels; and
at least three panel mounting structures projecting from the horizontal rotatable shaft, the panel mounting structure rotatable with the horizontal rotatable shaft, each panel mounting structure carrying one of the wind engaging panels;
a wind guide system, the wind guide system for assisting in directing the air flow towards the wind engaging panels while limiting air flow from engaging all the panels at the same time; and
a mechanism to convert the rotational energy of the shaft into another form of energy.

2. A system of claim 1 wherein the mechanism to convert the rotational energy of the shaft is an electrical generator and the another form of energy is electrical energy.

3. A system of claim 2 wherein the electrical generator is a fly wheel.

4. A system of claim 2 wherein the electrical generator is a permanent magnetic generator.

5. A system of claim 1 wherein the panels are covered with artwork.

6. A system of claim 1 wherein the wind guide system is a man-made physical structure.

7. A system of claim 6 wherein the wind guide system man-made physical structure is a panel.

8. A system of claim 7 wherein the wind guide system panel is adjustable.

9. A system of claim 7 wherein the wind guide system panel is covered with artwork.

10. A system of claim 6 wherein the man-made physical structure is formed of the same material as the wind engaging panels.

11. A system of claim 1 wherein the wind guide system is an earthen form.

12. A system of claim 11 wherein the earthen form is a berm.

13. A system of claim 11 wherein the earthen form is a sand dune.

14. A system of claim 1 wherein the wind guide system is a series of plants.

15. A system of claim 1 wherein the at least three wind engaging panels is four wind engaging panels wherein the air flow engages the panels generally perpendicular to the plane of the panel and in the direction of rotation of the panel.

16. A system of claim 1 wherein the wind engaging panels extend to a point near the horizontal shaft defining a gap between the panel and the shaft to allow air flow on all sides of the panel therein creating a low pressure area behind the panel to assist in the movement of the panel.

17. A system for generating energy from the movement of air, the system comprising:
a plurality of wind devices, each wind device including:
a mounting structure for securing to the ground;
a horizontal rotatable shaft, rotatably carried by the mounting structure;
at least three wind engaging panels; and
at least three panel mounting structures projecting from the horizontal rotatable shaft, the panel mounting structures rotatable with the horizontal rotatable shaft, each panel mounting structure carrying one of the wind engaging panels;
a wind guide system, the wind guide system for assisting in directing the air flow towards the wind engaging panels while limiting air flow from engaging all the panels at the same time; and
a mechanism to convert the rotational energy of the shaft into another form of energy.

18. A system of claim 17 wherein the plurality of the wind devices are aligned with each and have a common horizontal rotatable shaft.

19. A system of claim 18 wherein the panel mounting structures are staggered.
